(19) United States
(12) Patent Application Publication
(10) Pub. No.: US 2016/0087271 A1
(43) Pub. Date: Mar. 24, 2016

(54) Rechargeable Lithium Polymer Electrolyte Battery for Oilfield Use

(71) Applicant: Schlumberger Technology Corporation, Sugar Land, TX (US)

(72) Inventors: Christine Jarvis, Didcot (GB); David Teagle, Swindon (GB); Wendy Fraser, Stonehouse (GB); Susan Gilmore, Frocester (GB); Alex Bracken, Dursley (GB); David Betteridge, Cheltenham (GB); Norman Ward, Gloucester (GB); Wenlin Zhang, Houston, TX (US); Richard Frerker, Cheltenham (GB)

(21) Appl. No.: 14/495,839

(22) Filed: Sep. 24, 2014

(51) Int. Cl. H01M 4/485; H02J 7/00; E21B 17/02; H01M 4/131; H01M 4/1391

(52) U.S. Cl. CPC H01M 4/485; H01M 4/131; H01M 4/1391; E21B 17/028; H02J 7/00

(57) ABSTRACT

A battery for oilfield applications which may include: a housing and an electrolytic cell disposed in the housing. The electrolytic cell may include: a cathode, an anode, and a polymeric separator disposed between the cathode and anode. The cathode may include a cathode composite material coated on a substrate. The cathode composite material may include: a polymeric continuous phase; an active material; a carbon source; and; a first lithium salt. The anode may comprise lithium. The polymeric separator may include: a first polymer crosslinked by a photoinitiator; and a second lithium salt.

### BACKGROUND

Wells are generally drilled into the ground to recover natural deposits of oil and gas or other minerals that are trapped in geological formations. To drill a well, a drill bit is connected on the lower end of an assembly of drill pipe sections that are connected end-to-end so as to form a “drill string.” The bit is rotated by rotating the drill string at the surface or by actuation of downhole motors or turbines, or by both methods. A drilling fluid is pumped down through the drill string to the drill bit where it exits and carries drilled cuttings away from the bottom hole to the surface through the annulus between the drill string and the borehole wall.

In addition to the drill bit, the bottom hole assembly (“BHA”) commonly includes other tools, sensors, or equipment thereon used in the drilling process. Downhole tools may also be suspended in the wellbore on a wireline, which is lowered into the wellbore after the drilling process has completed or during interruptions in the drilling process when the drill string has been removed from the well.

Many of the tools, sensors, and other equipment used in downhole applications use electrical power in order to operate or actuate the device. Tools located on the drill string may be powered by a turbine or other motor through which the drilling fluid is circulated. However, when there is a lack of fluid circulation (or when the tool is located on a wireline), auxiliary power may be required. This auxiliary power may be in the form of a battery that is attached to the downhole tool. Some tools may be entirely powered by battery.

The hydrostatic pressure of the drilling fluid in the wellbore increases with increasing depth. In addition to increased pressure, temperatures experienced downhole also generally increase with increasing depth. Thus, downhole tools are often operated in a high temperature environment where temperatures may exceed 125° C. However, these downhole temperatures often exceed the normal operating range of commercial batteries.

Accordingly, there exists a continuing need for batteries that can operate at downhole conditions.

### SUMMARY

In one aspect, embodiments disclosed herein relate to a battery for oilfield applications. The battery may include: a housing and an electrolytic cell disposed in the housing. The electrolytic cell may include: a cathode, an anode, and a polymeric separator disposed between the cathode and anode. The cathode may include a cathode composite material coated on a substrate. The cathode composite material may include: a polymeric continuous phase; an active material; a carbon source; and; a first lithium salt. The anode may comprise lithium. The polymeric separator may include: a first polymer crosslinked by a photoinitiator; and a second lithium salt.

In another aspect, embodiments disclosed herein relate to a method for the fabrication of a battery. The method may include: preparing a composite cathode material comprising an active material, a carbon source, a first lithium salt and a polymeric continuous phase; preparing a polymeric separator comprising a polymer electrolyte by crosslinking the polymer electrolyte with a photoinitiator; coating the composite cathode material on a substrate to form a cathode; laminating the cathode with the polymeric separator; placing a lithium anode offset to the cathode to form a combined electrode; winding the combined electrode to form a elongated body; and electrically connecting the anode at one axial end of the elongated body and the cathode substrate at the other axial end of the elongated body to conductive components.

In another aspect, embodiments disclosed herein relate to a downhole system having a rechargeable lithium polymer battery. The downhole system may include at least one downhole tool disposed within a wellbore; and a battery, such as that described above, in electrical connection with the at least one downhole tool.

In another aspect, embodiments disclosed herein relate to a method for using a battery in oilfield applications. The method may include: discharging a battery, such as that described above, located on a tubular string and electrically connected to at least one downhole tool, to power the at least one downhole tool.

In another aspect, embodiments disclosed herein relate to a method for recharging a battery in oilfield applications. The method may include: charging a battery, such as that described above, located on a tubular string and electrically connected to a downhole motor.

This summary is provided to introduce a selection of concepts that are further described below in the detailed description. This summary is not intended to identify key or essential features of the claimed subject matter, nor is it intended to be used as an aid in limiting the scope of the claimed subject matter. Other aspects and advantages will be apparent from the following description and the appended claims.

### BRIEF DESCRIPTION OF DRAWINGS

FIG. 1 illustrates an example system in which the embodiments of the rechargeable lithium polymer battery may be implemented in a borehole.

FIG. 2 illustrates a cross-sectional view of an embodiment of a lithium polymer battery of the present disclosure.

FIG. 3 illustrates the offset design of a composite cathode and anode according to embodiments of the present disclosure.

### DETAILED DESCRIPTION

In the following detailed description of embodiments, numerous specific details are set forth in order to provide a more thorough understanding. However, it will be apparent to one of ordinary skill in the art that embodiments may be practiced without these specific details. In other instances, well-known features have not been described in detail to avoid unnecessarily complicating the description.

Embodiments of the present disclosure relate to lithium polymer electrolyte batteries as well as methods of making and using such batteries. Particular embodiments may involve the use of such batteries in a downhole environment to provide a power source to downhole tools. Further, in some aspects, the batteries of the present disclosure may not only be discharged downhole to provide power to one or more downhole tools but may also be charged or recharged while downhole from power generated from a downhole component, such as a turbine, that is in excess of that needed to power the downhole tools.

Battery Components

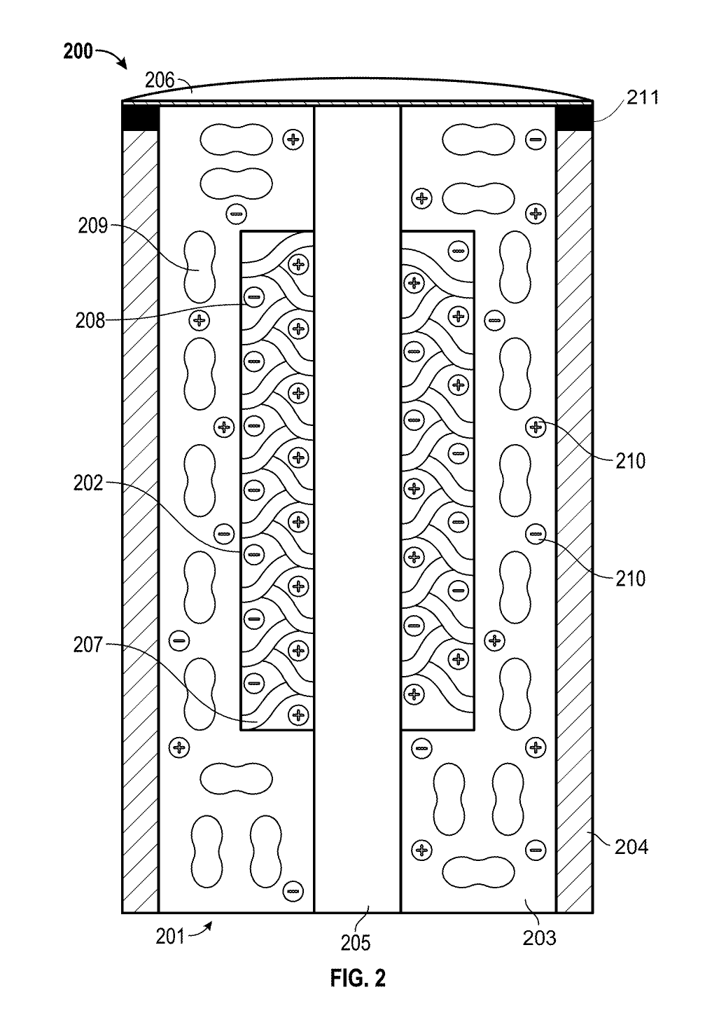

Referring to FIG. 2, a partial cross-sectional view of a battery according to one or more embodiments is shown. As shown in FIG. 2, a rechargeable battery (200) includes an electrolytic cell (201) disposed within a housing (not shown). Electrolytic cell (201) may include a composite cathode (202) coated on a substrate or a transition metal current collector (205), a polymeric separator (203), and an anode (204). Each of these components will be addressed in turn.

The housing (not shown) may be a steel can in which the electrolytic cell is deposited. The particular material used to form the housing (not shown) is of no limitation on the scope of the present disclosure. Rather, one skilled in the art can appreciate that the housing may be selected to be sufficiently capable of withstanding the high G-forces, temperatures, pressures, and corrosive environment experienced downhole within the wellbore. Alternative housing compositions may employ titanium, carbon reinforced alloys, and any other alloys, solid solutions or intermetallics that can retain structural integrity within the downhole environment. Further, it is also within the scope of the present disclosure that one or more components may be used to form the housing (not shown) including separate end pieces such as base plate (206). Further, in some embodiments the anode may be separated from one or more base plates, if present, by insulation, including for example an insulating washer (211), to prevent the creation of a short circuit with the cathode. One skilled in the art would appreciate that separate end pieces (at both ends of the cell) may be desired for manufacturing ease. When multiple pieces are used to form the housing, one of ordinary skill in the art would appreciate that a hermetic seal may be formed between the multiple components.

Referring back to FIG. 2, the composite cathode (202) may include an active material, a carbon source, a polymer continuous phase (207) and a first lithium salt (208). In some embodiments, the active material may be a vanadium oxide with a formula of VOₓ, where x ranges from 0.5 to 3. In particular embodiments, the active material is V₆O₁₃ Vanadium is multivalent, that is, vanadium may exist in multiple oxidation states, such as +2, +3, +4 or +5. Therefore, the formula may also be expressed as (V₂)ₙ(V₃)ₘ . . . Oₓ, where V₂, V₃, and succeeding Vₛ refer to different oxidation states, while n and m and succeeding letters refer to the value at which the different oxidation states are present within the active material in order to maintain charge neutrality for the desired x value. However, it is also within the scope of the present disclosure that the ratio between the vanadium and oxygen does not need to maintain charge neutrality within the active material. Rather, deficiencies or surpluses in the oxygen content may be present in order to modify the ionic and electrical transport properties of the active material. The active material may be a homogeneous or heterogeneous mixture of crystalline, nanocrystalline, amorphous, or glassy vanadium oxides (or other active material).

However, it is also within the scope of the present disclosure that any lithium intercalation material may be used in the active material, such as, but not limited to LiFePO₄, LiV₃O₈, V₂O₅, Li₄Ti₅O₁₂. The active material may form, for example, between about 50 and 80 weight percent of the composite cathode, and between about 60 and 70 weight percent in one or more embodiments. Further, in one or more embodiments, the cathode material may have a particle size of less than 10 microns.

The active material may optionally be a doped multinary vanadium oxide compound, where the cation or anion can be substituted with an element of a comparable charge in order to maintain neutral charge balance in the active material. “Doping” refers to a process where another element is introduced to a system in a controlled fashion as a dopant. It is also within the scope of the present disclosure that vanadium oxide may be interstitially doped. “Interstitial doping” refers to a dopant whose size is small enough to fit within a void space between the primary atoms in a given solid state compound. As such, alkali group, main group and transition metal elements that possess an atomic diameter smaller than the void space in a vanadium oxide may be added to the active material. Such elements can include Na, Mg, K, CA, Sc, Ti, V, Cr, Mn, Fe, Co, Ni, Cu, Zn, Rb, Sr, Y, Zr, Nb, Mo, Ru, Rh, Pd, Ag and Cd.

The carbon source used in the composite cathode may take the form of graphite or carbon black (such as acetylene black), for example. However, other forms of carbon, such as carbon nanomaterials or materials that generate carbon in situ may be used in other embodiments. For example, in some embodiments, carbon may be formed in situ through the decomposition of carbon precursors. However, the choice of carbon precursor may be dependent on the active material so that the carbon precursor is not reactive with the active material. Further, the temperature and atmosphere of decomposition should be taken in consideration to ensure there are no side reactions which can reduce the power density of the battery. The carbon content may be dependent upon both the type of active material and the type of carbon used. However, in some embodiments, the amount of carbon present in the composite cathode may fall within the range of 1 to 15 weight percent of the composite cathode, such as for V₆O₁₃, and within the range of 3 to 5 weight percent in other embodiments.

The composite cathode may also include a polymer continuous phase (207) in which the active material and carbon source are dispersed. In accordance with embodiments disclosed herein, the polymer continuous phase may serve as a matrix through which electrolytes may flow. Thus, the polymer continuous phase, in conjunction with a first lithium salt, may function as a polymer electrolyte where the polymer continuous phase may possess transport properties comparable with that of a common liquid ionic solution. In general, the polymer continuous phase may also possess one or more of the following properties: 1) a high ionic conductivity at operating temperatures, 2) good mechanical strength, 3) appreciable lithium transference number, 4) high thermal and electrolytic stability to withstand the pressures inside the electrolytic cell, and 5) compatibility with the electrodes. For example, in one or more embodiments, the conductivity may be above 10⁻³ Scm⁻¹ at temperatures above 100° C. As such, the polymer continuous phase used in the composite cathode may be 1) a dry solid-state polymer, 2) a gel/plasticized polymer, and/or 3) a polymer composite. Such polymer continuous phase may form from about 20 to 50 weight percent of the composite cathode, and from 30 to 40 weight percent in other embodiments.

In accordance with embodiments, the polymer continuous phase (207) may be formed from a polyalkylene oxide, such as a polyethylene oxide (PEO) or a polypropylene oxide (PPO), a polyethylene imine (PEI), with or without comonomers, or from any polyoxyalkylene glycol. The polymers forming polymeric continuous phase (207) may be linear, linearly branched, comb, dendritic, or a mixture of the above forms through crosslinking. In addition, the polymer continuous phase (207) may be in a homogeneous crystalline or amorphous state or a heterogeneous mixture of the two.

In addition, the composite cathode may also include a salt therein. In some embodiments, the first lithium salt (208) in the composite cathode may be selected from a group of multinary halides, multinary chalcogenides or multinary oxides. “Multinary” refers to compounds that may include simple binary compounds with a general non-stoichiometric formula of AX, tertiary compounds with a general non-stoichiometric formula of ABX or AXY, and/or quaternary compounds with a general non-stoichiometric formula of ABXY, etc where A and B refer to generally electropositive elements or chemical moieties, and X and Y refer to a generally electronegative elements or chemical moieties. One skilled in the art can appreciate that multinary can also cover combinations of elements greater than quaternary compounds with virtually no limit on components. For example, another alkali metal, main group, or transition metal element may be added to the cation site of the lithium salt while still maintaining charge neutrality of the salt. Further, highly electronegative elements may be added to the anion site of the lithium salt while still maintaining charge neutrality. As such, organic lithium salts, mixed halide salts, mixed chalcogenide salts, phosphosalts, sulfosalts, arsenates, tellurates, mixed halide phospho/sulfo salts, chalcooxide salts, etc may be used. One skilled in the art can appreciate that the embodiments are not limited to the list above. In one or more embodiments, the first lithium salt may include lithium (bis) trifluoromethanesulfonimide (Li imide), lithium bis(oxalato)borate (LiBOB), lithium tetrafluoroborate (LiBF₄), lithium bis(perfluoroethylsulfonyl) imide (LiBETI).

The first lithium salt may be present in the composite cathode in an amount such that the molar ratio of heteroatom in the polymer continuous phase (207) to the lithium in the first lithium salt (208) may be in the range of 10:1 to 30:1, which may also be referred to as the O:Li ratio for a polyalkylene oxide or polyoxyalkylene glycol or as the N:Li ratio for a polyethylene imine. In other embodiments, the heteroatom to Li ratio of the polymer continuous phase (207) to the first lithium salt (208) may be at least 25:1, and about 26.7:1 in a particular embodiment. One skilled in the art can appreciate that the selection of the ratio may depend, in part, on the selection of the lithium salt as well as the selection of the polymer type. Further, in one or more embodiments, it is also within the scope of the present disclosure that the cathode does not include any salt added thereto and instead relies on migration from the electrolyte.

The composite cathode (202) may be coated on a substrate which functions as a current collector during battery operation (205). In some embodiments, the substrate/current collector may be a transition metal or an aluminum based material. In particular embodiments, the substrate/current collector may be nickel. However, transition metals with at least a similar electrical conductivity to nickel, or transition metal based intermetallics, solid solutions, and alloys may be used as well. Further, in one or more embodiments, the current collector may be aluminum or a carbon coated aluminum material.

Adjacent composite cathode (202) (and between composite cathode (202) and anode (204)) is polymeric separator (203). The polymeric separator may be primarily composed of a polymer and serves to physically separate the cathode and the anode to reduce or avoid short circuits therebetween. In embodiments, the polymeric separator is formed of a polymer having a dynamic viscosity sufficiently high such that the polymer exhibits substantially no flow at temperatures of up to 125° C. and pressures up to 1400 kPa. A second lithium salt (210) may also be dispersed within the polymeric separator to allow for the conductance of ions through the separator. Together, the polymer and the lithium salt may function as a second polymer electrolyte phase through which the ions can flow, in addition to the polymer's physical separation functionality.

The polymer (209) of the polymeric separator (203) may be a polyoxyalkylene, such as polyethylene oxide (PEO) or polypropylene oxide (PPO), or polyacrylonitrile, and in particular embodiments, may have a weight average molecular weight ranging from 100,000 to 4,500,000 g/mol. As mentioned above, the polymer (and its molecular weight) may also be selected to achieve a sufficiently high dynamic viscosity such that the polymer has substantially no flow in the absence of polymer degradation. Thus, for a polymer having a lower molecular weight, crosslinking may be utilized to achieve a more rigid structure to reduce flow of the polymer. As the presence of branching and/or selected molecular weight increases, less (or no) crosslinking may be needed to achieve the desired viscosity. Thus, in light of the teachings of this disclosure, one skilled in the art would appreciate that molecular weight, branching, and crosslinking may be varied and selected so long as molecular weight, branching and/or crosslinking are sufficiently high to reduce or minimize flow of the polymer under downhole conditions. Thus, the structure of the polymer forming the polymer separator may be linear, linearly branched, comb, dendritic, or a mixture of the above forms through crosslinking. In addition, such polymer may be in a homogeneous crystalline or amorphous state or a heterogeneous mixture of the two.

The second lithium salt (210) in the polymeric separator (203) may be selected from a group of multinary halides, multinary chalcogenides or multinary oxides. Similar to the first lithium salt (208), another alkali metal, main group, or transition metal element may be added to the cation site of the lithium salt while still maintaining charge neutrality of the salt. Further, highly electronegative elements may be added to the anion site of the lithium salt while still maintaining charge neutrality. As such, organic lithium salts, mixed halide salts, mixed chalcogenide salts, phosphosalts, sulfosalts, arsenates, tellurates, mixed halide phospho/sulfo salts, chalcooxide salts, etc may be used. One skilled in the art can appreciate that the embodiments are not limited to the list above. In one or more embodiments, the first lithium salt may include lithium (bis) trifluoromethanesulfonimide (Li imide), lithium bis(oxalato)borate (LiBOB), lithium tetrafluoroborate (LiBF₄), lithium bis(perfluoroethylsulfonyl) imide (LiBETI).

In some embodiments, the concentration of the second lithium salt (210) in the polymeric separator may be in the range of 25-65 wt. % of the polymer. In other embodiments, the salt may be present in the polymeric separator in an amount ranging from a lower limit of any of 25, 30, 32, 35, 40, or 45 weight percent of the polymer to an upper limit of any of 35, 40, 45, 50, 60, or 65 weight percent of the polymer, where any lower limit may be used in combination with any upper limit.

The second lithium salt may be present in the polymeric separator in an amount such that the heteroatom to lithium molar ratio for the polymer (209) to the second lithium salt (210) may be in the range of 10:1 to 30:1, and in one or more embodiments may be in the range of 15:1 to 20:1.

In some embodiments, an inert mesh or porous film, such as a polyimide mesh or film, may be incorporated in the polymeric separator (203), thereby improving the mechanical properties. The selection or choice of mesh or separator may be dependent on the ability of the material being able to operate over the temperature range of the cell.

In some embodiments, a non-reactive filler may be added to the polymeric separator (203) to affect the mechanical properties of the separator. In some embodiments, this non-reactive filler may be fumed silica, such as those available under the tradename CAB-O-SIL® from Cabot Corporation (Boston, Mass.). Further, in addition to silica, alumina, and/or other inert transition metal oxide particles may be added to the polymeric separator alone or in combination with each other. In other embodiments, the nonreactive filler may also be multinary silicates, multinary aluminates and/or other multinary transition metal oxides.

As mentioned above and illustrated in FIG. 2, the polymeric separator (203) separates the composite cathode (202) from anode (204). In accordance with embodiments of the present disclosure, anode (204) may be a lithium-containing anode. Specifically, the lithium-containing anode may be pure lithium or various lithium compounds that may be utilized according to the embodiments of the disclosure. In one or more particular embodiments, the anode may be pure lithium foil.

Further, the anode (204) may be selected to possess sufficient mechanical strength for processing without support without having a great excess of lithium in the cell. In some embodiments, the anode possesses a thickness of at least 150 μm, or at least 140, 130, 125, 120, 110, or 100 microns in various other embodiments, and up to 150, 160, 175, or 200 microns in one or more embodiments.

Offset Design

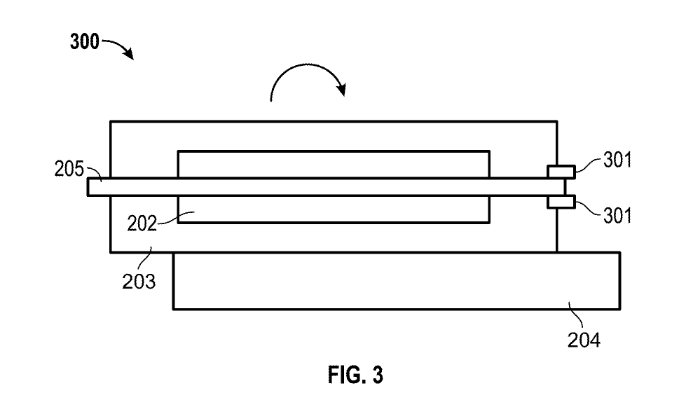

Referring now to FIG. 3, cross-sectional view of an embodiment of a design of an electrolytic cell is shown. As shown in FIG. 3, electrolytic cell (300) includes a composite cathode material (202) coated on a cathode substrate/current collector (205). A polymeric separator (203) may be laminated with (and thus interfacing and/or surrounding) composite cathode (202). Adjacent polymeric separator (203) (and spaced from cathode material (202)) is anode (204). In accordance with embodiments of the present disclosure, when the cathode/current collector, separator, and anode layers are interfaced with one another, the axial end(s) of the current collector and polymeric separator may be offset from the same axial end(s) of the anode. When the layers of the components forming the electrolytic cell are wound into a cylindrical body (or other elongated form), the cathode substrate/current collector projects from one axial end of the body and the anode projects from the opposite axial end. It is within the scope of the present disclosure that each of the cathode, current collector, separator, and anode may be formed using the above-described components; however, it is also intended that the off-set design of the present disclosure may be used with other cell components/formulations without departing from the scope of the present disclosure. Similarly, the methods used in forming such a design are also within the scope of the present disclosure without necessarily being limited to the type of chemistry described above.

Fabrication of Lithium Polymer Batteries

In general, some embodiments are directed to methods of fabricating lithium polymer batteries that can be used in downhole applications. The method may include coating a substrate (or current collector) with the composite cathode material; lamination of the composite cathode with the polymeric separator; combining the anode with the cathode-coated substrate in an offset manner and into an elongated body; and electrically connecting the electrodes to conductive components. Such steps may result in the formation of an electrolytic cell having the anode and cathode-coated substrate projecting from the opposite axial ends of the elongated battery to allow for common terminals.

In some embodiments, the method may also include preparation of the components forming the electrolytic cell, such as the cathode materials and the polymeric separator. As mentioned above, some embodiments of the present disclosure involve the use of a composite cathode material having an active material, a carbon source, a first lithium salt and a polymeric continuous phase, and thus the methods of the present disclosure may include preparation of such composite cathode material. In accordance with some embodiments, the active material may be premixed with the carbon source and the polymer may be premixed with the lithium salt; however, other embodiments may involve mixing all components together at once, sequential addition, or pre-mixing different combinations of the cathode components.

For example, in some embodiments, the active material and the carbon source may be pre-mixed to achieve thorough uniform distribution and close contact between the particles in a formed composite cathode, which may result in good electrolytic performance including ionic and electrical conductivity. Such pre-mixing may involve use of ball milling, a mechanofusion processing (a method designed to produce solid-solid composite materials in a dry process by applying mechanical force) or mixing the active material and the carbon source in a high shear mixer such as a DISPERMAT® mixer available from VMA-GETZMANN GMBH Verfahrenstechnik (Reischoff, Germany).

In some embodiments, the composite cathode materials may be prepared as a slurry to be coated onto a substrate that will serve as a current conductor. In such embodiments, the polymer (and/or salt, active material, and carbon source) may be mixed into a solvent in which the polymer may be at least partially soluble (or dispersible in other embodiments) in some particular embodiments. There is no limitation of the breadth of solvents that may be used, but in some embodiments, it may be desirable to select a solvent in which the polymer forming the polymer continuous phase can be solvated, dispersed, or solubilized and/or a solvent that can be entirely removed from the cathode material by evaporation and/or drying. In some embodiments, the solvent may be selected from acetonitrile and/or propan-2-ol alone or in combination with each other or another solvent. Further, in some embodiments, it may be particularly desirable to use anhydrous solvent(s) to reduce or minimize the presence of water in the cathode formulation. In some embodiments, after a polymer slurry is produced, the salt may be added (or may be added with the polymer or may be dissolved in the solvent prior to addition of the polymer) followed by the active material and carbon source. The amount of slurry used may depend on the polymer selected and the amount of each component including the polymer, salt, active material, and carbon source. However, one skilled in the art would appreciate that using less solvent will require less drying. In one or more embodiments, for example, to produce a slurry containing between 30 to 50 wt % solids, more preferably approximately 40 wt % solids, a solvent mixture of approximately 40% acetonitrile to 60% propan-2-ol may be used.

In some embodiments, the slurry of cathode components may be coated onto a substrate (that will act as a current collector) using a doctor blade coating method or other coating techniques such as slot die extrusion. The coated cathode film may also be pressed through a calender or by other pressing mechanisms known in the art to reduce or minimize porosity.

The polymeric separator may be formed using similar solvents as described with respect to the composite cathode. In such embodiments, the polymer of the polymeric separator may be mixed into a solvent in which the polymer may be at least partially soluble (or dispersible in other embodiments) in some particular embodiments. There is no limitation of the breadth of solvents that may be used, but in some embodiments, it may be desirable to select a solvent in which polymer can be solvated, dispersed, or solubilized and/or a solvent that can be entirely removed from the polymeric separator by evaporation and/or drying. In some embodiments, the solvent may be selected from acetonitrile and/or propan-2-ol alone or in combination with each other or another solvent. Further, in some embodiments, it may be particularly desirable to use anhydrous solvent(s) to reduce or minimize the presence of water in the polymeric separator formulation. In some embodiments, after a polymer slurry is produced, the salt may be added in (or may be added with the polymer or may be dissolved in the solvent prior to addition of the polymer), followed by or in conjunction with an optional filler which may also be added to the solvent prior to the addition of the polymer. The amount of slurry used may depend on the polymer selected and the amount of each component, including the polymer, salt, and optional filler. However, one skilled in the art would appreciate that using less solvent will require less drying. Further, in one or more particular embodiments, acetonitrile may be used as the solvent for polymer electrolyte mixing.

In some embodiments, the slurry of polymer and second lithium salt (forming the polymeric separator layer) may be coated onto an inert substrate (such as a silicon coated paper or polymer material) using a doctor blade coating method or may be produced by extrusion techniques such as slot die extrusion to form the polymeric separator layer. In some embodiments, an inert mesh or porous film (e.g., a polyimide mesh or film) may be incorporated in the polymeric separator and thus may serve as the inert substrate on which a polymer slurry may be coated. Other embodiments may use a separate substrate which is subsequently removed from the polymer layer prior to assembly of the cell components together. Incorporating a mesh into the polymer electrolyte during coating process may also require a carrier web. A support mesh could be laminated/pressed into the electrolyte film.

As mentioned above, in some embodiments, the polymer in the polymeric separator may optionally be crosslinked to increase the dynamic viscosity of the layer. Thus, in some embodiments, the polymer of the polymeric separator may be exposed to a radiation source in order to produce a crosslinked polymer. The radiation source may emit electron beams, gamma radiation or UV-light. One skilled in the art would appreciate that the radiation intensity and/or exposure time to the radiation source may be selected depending on the degree of crosslink density desired.

Further, crosslinking the oligomers or polymers may also be performed through chemical reactions that are initiated by heat, pressure, change in pH or radiation. In some embodiments, a crosslinking reagent may be used to crosslink oligomers and polymers of the polymeric separator and/or polymer continuous phase. For example, the addition of hydrogen peroxide to polyethylene oxide (or other polyalkylene oxides) may initiate crosslinking with the addition of heat which can be obtained through the use of hot melt extrusion. However, in one or more other embodiments, crosslinking may be initiated by UV radiation.

In one or more embodiments, crosslinking may be initiated with the assistance of a photoinitiator, which generates free radicals upon exposure to light, including visible, UV, and/or x-ray radiation. Upon exposure to radiation, such as UV radiation, a variety of photochemical transformations may occur, for example, the UV initiator may form free radical reactive fragments that react with the backbone of the polyalkylene oxide, which initiates crosslinking of the polymer. Such photoinitiators may include one or more of acyl phosphine oxides, alpha hydroxyl ketones, or benzophenones. In particular embodiments, a mixture of two or more of an acyl phosphine oxide, alpha hydroxyl ketone, or benzophenone may be used, and in even more particular embodiments, one of each type of acyl phosphine oxide, alpha hydroxyl ketone, and benzophenone may be used.

In one or more embodiments, an acyl phosphine oxide may be acylphosphine oxide compound of the formula (1)

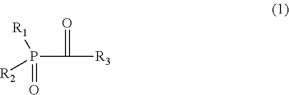

R₁ and R₂ independently of one another are C₁-C₁₈ alkyl, C₂-C₈ alkyl interrupted by one or more O atoms, phenyl-substituted C₁-C₄ alkyl, C₂-C₁₈ alkenyl, phenyl which is unsubstituted or is substituted from one to five times by halogen, hydroxyl, C₁-C₈ alkyl and/or C₁-C₈ alkoxy, naphthyl which is unsubstituted or substituted from one to five times by halogen, hydroxyl, C₁-C₈ alkyl and/or C₁-C₈ alkoxy, biphenyl which is unsubstituted or substituted from one to five times by halogen, hydroxyl, C₁-C₈ alkyl and/or C₁-C₈ alkoxy, or are C₃-C₁₂ cycloalkyl, an O-, S-, N-containing 5- or 6-membered heterocyclic ring or a group COR₃; or R₁ is —OR₄ or a group

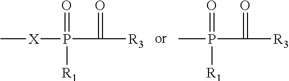

R₁ and R₂ together are C₄-C₈ alkylene and, with the P atom to which they are attached, form a ring structure;

R₃ is C₁-C₁₈ alkyl, C₃-C₁₂ cycloalkyl, C₂-C₁₈ alkenyl, phenyl, naphthyl or biphenyl each of which is unsubstituted or substituted from one to four times by C₁-C₈ alkyl, C₁-C₈ alkoxy, C₁-C₈ alkylthio and/or halogen, or is an O-, S- or N-containing 5- or 6-membered heterocyclic ring or a group

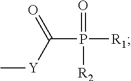

R₄ is C₁-C₈ alkyl, phenyl or benzyl;

Y is phenylene, C₁-C₁₂ alkylene or cyclohexylene; and

X is C₁-C₁₈ alkylene or a group

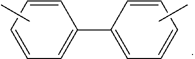

In specific embodiments, the acyl phosphine oxide is at least one bisacylphosphine oxide class of formula (1a)

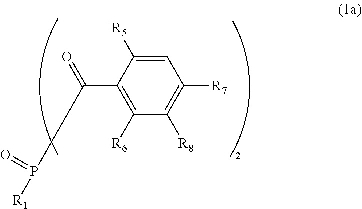

Wherein R₁ is C₁-C₁₂ alkyl, cyclohexyl or phenyl which is unsubstituted or substituted from one to four times by halogen and/or C₁-C₈alkyl, R₅ and R₆ are each independently of the other C₁-C₈ alkyl, R₇ is hydrogen or C₁-C₈ alkyl, and R₈ is hydrogen or methyl.

Examples of suitable phosphine oxide compounds of the formula (1) for use compositions according to the present disclosure are: 2,2-dimethyl-propionyldiphenylphosphine oxide, 2,2-dimethyl-heptanoyl-diphenylphosphine oxide, 2,2-dimethyl-octanoyl-diphenylphosphine oxide, 2,2-dimethyl-nonanoyl-diphenylphosphine oxide, methyl 2,2-dimethyl-octanoyl-phenylphosphinate, 2-methyl-2-ethyl-hexanoyl-diphenylphosphine oxide, 1-methyl-1-cyclohexanecarbonyl-diphenylphosphineoxide, 2,6-dimethylbenzoyl-diphenylphosphine oxide, 2,6-dimethoxybenzoyl-diphenylphosphine oxide, 2,6-dichlorobenzoyl-diphenylphosphine oxide, methyl 2,6-dimethoxybenzoyl-phenylphosphinate, 2,4,6-trimethylbenzoyl-diphenylphosphine oxide, methyl 2,4,6-trimethylbenzoyl-phenylphosphinate, 2,3,6-trimethylbenzoyl-diphenylphosphine oxide, 2,3,5,6-tetramethylbenzoyl-diphenylphosphine oxide, 2,4,6-trimethoxybenzoyl-diphenylphosphine oxide, 2,4,6-trichlorobenzoyl-diphenylphosphine oxide, 2-chloro-6-methylthio-benzoyl-diphenylphosphine oxide, methyl 2,4,6-trimethylbenzoyl-naphthylphosphinate, 1,3-dimethoxynaphthalene-2-carbonyl-diphenylphosphine oxide, 2,8-dimethoxynaphthalene-1-carbonyl-diphenylphosphine oxide, 2,4,6-trimethylpyridine-3-carbonyl-diphenylphosphine oxide, 2,4-dimethylquinoline-3-carbonyl-diphenylphosphine oxide, 2,4-dimethoxyfuran-3-carbonyl-diphenylphosphine oxide and methyl 2,4-dimethylfuran-3-carbonyl-phenylphosphinate.

The compositions according to the present disclosure may contain phosphine oxide compounds of the above formula as the sole photoinitiator, or with a combination of other photoinitiators. The ranges of the phosphine oxide may range in amount of from 0.005 to 10, especially from 0.005 to 5, percent by weight based on the total amount of the photopolymerizable composition.

In one or more embodiments, the α-hydroxy ketone compounds are, in particular, compounds of the formula II

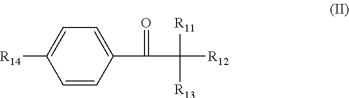

R₁₁ and R₁₂ independently of one another are hydrogen, C₁-C₆ alkyl, phenyl, C₁-C₆ alkoxy, OSiR₁₆(R₁₇)₂ or —O(CH₂CH₂O)_{q}—C₁-C₆ alkyl, or

R₁₁ and R₁₂, together with the carbon atom to which they are attached, form a cyclohexyl ring;

q is a number from 1 to 20;

R₁₃ is OH, C₁-C₁₆ alkoxy or —O(CH₂CH₂O)_{q}—C₁-C₆ alkyl;

R₁₄ is hydrogen, C₁-C₁₈ alkyl, C₁-C₁₈ alkoxy, —OCH₂CH₂—OR₁₅, a group CH₂═(CH₃)— or

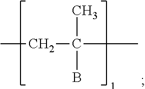

1 is a number from 2 to 10;

B is the radical

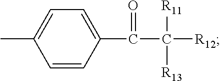

R₁₅ is hydrogen,

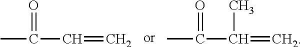

R₁₆ and R₁₇ independently of one another are C₁-C₈ alkyl or phenyl.

Examples of suitable a-hydroxy ketone compounds of the formula (II) for use compositions according to the present disclosure are: α-hydroxycyclohexyl phenyl ketone, 2-hydroxy-2-methyl-1-phenylpropanone, 2-hydroxy-2-methyl-1-(4-isopropylphenyl)propanone, 2-hydroxy-2-methyl-1-(4-dodecylphenyl)propanone and 2-hydroxy-2-methyl-1-(2-hydroxyethoxy)phenylpropanone.

In one or more embodiments, the benzophenone compounds are, in particular, compounds of the formula III

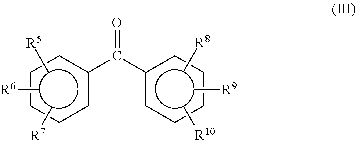

where R⁵, R⁶ and R⁷ independently are C1-C₁₂-alkyl, CᵣC₄-alkylthio, C1-C4-alkoxy, halogen or C₂-C₆-alkoxycarbonyl and R⁸, R⁹and R¹⁰ are hydrogen, C1-C₁₂-alkyl, C1-C₄-alkoxy, halogen or C₂-C₆-alkoxycarbonyl or CC-alkylthio.

In one or more embodiments, the benzophenone compounds are, in particular, compounds of the formula IV

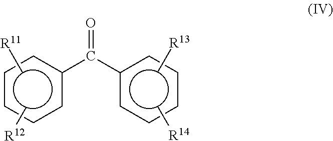

where R¹¹, R¹², R¹³ and R¹⁴ independently are hydrogen, C1-C₁₂-alkyl, C1-C₄-alkoxy, Ct-C₄ -alkylthio, halogen or C₂-C₆-alkoxycarbonyl.

Examples of benzophenones include, for instance, benzophenone, alkyl-substituted benzophenone (e.g. 2-methylbenzophenone, 3-methylbenzophenone, or 4-methylbenzophenone), alkoxy-substituted benzophenone (e.g. 4-methoxybenzophenone), 4-morpholinobenzophenone, and 4,4′-bis(N,N′-dimethylamino)-benzophenone.

In one or more embodiments, the composition contains at least 0.1 wt % of photoinitiator, based on the total weight of the composition. In one or more embodiments, the amount of photoinitiator(s) can range from about 0.1 wt % to about 10 wt %, based on the total weight of the composition. In one or more embodiments, the amount of photo initiator(s) can range from a low of about 0.1 wt %, 0.2 wt %, 0.3 wt %, 0.5 wt %, or 1 wt %, to a high of about 2.5 wt %, 3 wt %, 5 wt %, or 8 wt %, based on the total weight of the composition. In one or more embodiments, the amount of photoinitiator(s) is about 1 wt % to about 3 wt %, based on the total weight of the composition. In one or more embodiments, the amount of photo initiator(s) is about 1 wt %, 1.5 wt %, or 2 wt %, based on the total weight of the composition. Further, when multiple photoinitiators are used, amount of each component, relative to the sum of all of the photoinitiators may range from 0.5 to 99.5 wt % or from 1.0 to 40 wt %, or from 5 to 30 wt %.

Particular embodiments may use a blend of (1) 2,4,6-trimethylbenzophenone, (2) 4-methylbenzophenone; and, (3) oligo(2-hydroxy-2-methyl-1-4-methylvinyl)phenyl)propanone. In one or embodiments these photoinitiators are present in a respective weight ratio ranges of 0.5-1.0:0.03-1.0:0.5-1.0.

Depending on the salt concentration selected for the polymeric separator layer and the molecular weight of the polymer as well degree of crosslinking, steps used in forming and handling the polymeric separator may be adjusted accordingly. Specifically, the salt concentration (such as those ranges discussed above) may affect the tackiness of a layer resulting in an effect to handling, lamination, and winding, for example. Lower salt concentrations (for example, 25 or 30 weight percent to 35 weight percent, or an O:Li ratio of 26:1 to 19:1) may be handled easily, but lack tackiness, and thus warming the layer during lamination (and/or prior to winding) may be desirable to achieve lamination to the cathode (and/or a tightly wound cell). However, warming may result in greater difficulty in removing an inert substrate, thus in such an instance, it may be desirable to use a mesh or film as a substrate that need not be removed during fabrication. Further, the nature of electrolyte film is that it may need to be coated onto a carrier, and thus it may be easier to remove if a reinforcing mesh is used in the electrolyte film. That is, in one or more embodiments, the cathode could be used as a carrier.

After preparation of the composite cathode and the polymeric separator, it may be desirable to laminate the two layers together prior to assembly with an anode. In particular embodiments, the polymeric separator may be laminated on both sides or surfaces of a composite cathode sheet to separate the cathode from the anode after winding. In some embodiments, pressure may be required to laminate the polymeric separator to each side of the composite cathode. Use of a single roll which is covered with a material that can deform under stress, such as rubber or high density polyethylene, may be desirable, compared to the use of two steel rolls, to achieve improved lamination. Depending on the choice of the polymer and salt in the polymeric separator, in some embodiments, heat may also be required during lamination.

In one or more embodiments, crosslinking of the polymeric separator may occur prior to or after lamination with a cathode, as described herein. In some embodiments, when crosslinking the polymeric separator after lamination with the cathode, measures may be taken in order to prevent or minimize crosslinking of the polymer content in the cathode. For example, if a high energy radiation source is used, energy may be directed to the bulk of the electrolyte, and intensity and exposure time during focusing may be reduced to protect the cathode. For embodiments in which the polymer separator is chemically crosslinked, the crosslinking agent may be selectively incorporated into the polymeric separator, and polymer crosslinking may be initiated before significant diffusion of the crosslinking agent into the cathode. In some possible embodiments in which heat is the driver of crosslinking reaction within the polymeric separator, manufacturing techniques may be developed in which the polymeric separator is selectively warmed and/or the cathode is cooled relative to the polymeric separator layer.

As mentioned above, the cathode and anode may be assembled offset with respect to one another (and wound) to produce a cell having the cathode substrate (i.e., substrate on which the composite cathode material is coated) and anode projecting axially from different ends of an elongated body. FIG. 3 illustrates a cross-sectional view of the offset combined electrode (300) used in fabrication processes of the present disclosure. The combined electrode (300) may include the composite cathode-coated (202) substrate/current collector (205) projecting at one axial end, and the anode (204) projecting at the other axial end, with the polymeric separator (203) therebetween. Upon assembly of the cathode, polymeric separator, and anode together, the common electrode may be wound into an elongated body.

Prior to assembly, however, it may also be desirable to mask or insulate one end of the cathode substrate to reduce likelihood of short circuit in the assembled and final cell. Masking or insulation may be achieved by placing a thin adhesive tape (301) on both sides of one end of the cathode substrate (current collector) 205 (the end that will not project axially from the elongated body) to prevent direct contact between the cathode substrate and the anode after assembly and winding. The ends of the adhesive tape may be joined together where the tape overhangs the cathode substrate and optionally trimmed to reduce surface area. Alternatively, a single piece of tape may be wrapped to cover both sides of the cathode substrate. Any adhesive tape may be used that is compatible with the cell components and also capable of withstanding temperatures at least 10° C. above the cell's upper operating temperature. Additionally, it may also be desirable to use a tape thinner than the deposited cathode layer so that the tape does not contribute to an increased thickness in the wind.

Upon assembly of the common electrode and to initiate winding, in some embodiments, a central mandrel may optionally be incorporated in the cell to provide a solid fixture on which to wind the coil pack. To achieve electrical connection and physical contact, one electrode may be spot welded to the central mandrel. In some embodiments, the composite cathode-coated substrate/current collector may be welded to the central mandrel. Alternatively, the anode may be welded to the central mandrel. In addition, the welded area and the exposed electrode may be covered with polyimide tape to aid in the adhesion to the mandrel and/or to cover any sharp edges that may have been produced as part of the welding process. In such an embodiment, additional components, such as an anode current collector may also be incorporated.

Upon welding the desired electrode to the central mandrel, the central mandrel may be wrapped with one or two layers of the selected electrode prior to introducing the first layer of the other electrode. For example, in particular embodiments, the central mandrel may be welded to the cathode, and at least one rotation of the cathode/polymeric separator laminate may be performed around the central mandrel before introducing the anode to the winding process. A tight wind may be achieved by applying tension to cathode/polymer laminate, and the wind may be continued to a set diameter or electrode length to produce an elongate body. The anode may then be cut so that the end is encapsulated with the cathode/polymeric separator laminate. A final wrap of polyimide (or a similar film material) may then be introduced to secure the wind.

Upon completion of the winding, the elongate body may have multiple “layers” of the cathode substrate and anode projecting from different axial ends of the body. Based on a wound structure, the layers would not be separate layers, but a continuous spiral or coil of electrode, that effectively become such layers. To improve efficiency and current flow, the coil layers may optionally be interconnected to produce a common terminal at each end of the elongate body. It is also possible that the coil layers of electrode, for example, the cathode substrate, may be in direct contact with a conductive base plate that will serve as the common terminal. In such an embodiment, the base plate may be profiled in order to improve contact with the cathode substrate/current collector. Further, a mesh may be welded to the base plate which will then push into the cathode substrate/current collector for improved contact. In addition, it is also envisioned that the cathode substrate/current collector may be crimped or crushed together to improve the contact with the base plate and/or metal interconnect tags (such as nickel or stainless steel tags) may be welded across the cathode substrate/current collector layers to provide connection using for example a reflow soldering technique or an ultrasonic welding technique. A reflow soldering technique may incorporate a thin sliver of solder between the metal tag and cathode substrate/current collector, to which heat is applied through the use of a resistance welder to allow a solder joint to be made. These tags may optionally be extended and welded to the side or base of a housing in which the assembled cell is placed to help maintain positioning of the cell within the housing. Additionally and/or alternatively, a metal deposition method, such as arc spraying, may be used to connect the cathode layers, and may use copper or other metals that are compatible with the cell components. Another method may involve the use of washers of a conductive material, such as carbon felt, to bridge the gap between a base plate and cathode substrate/current collector. Conducting glues and/or resins that cure at low temperature may also be suitable to connect the cathode substrate/current collector layers alone or used in combination with any of the above described techniques.

Similar to the cathode substrate, the anode end of the cell may be interconnected to produce a common terminal. Such interconnection may be achieved by pressing the coil layers of the anode together; welding the coil layers to a metal tag; depositing a metal spray thereon; and/or pressing the ends into a metal disc, each of which may be used alone or in combination with one another. In a particular embodiment, the common terminal may then be welded to the cell lid, such as to the pin of the glass to metal seal formed in the cell lid. In such embodiments, the tag or spray may be copper. Further, in one or more embodiments, a tag to connect from a copper deposit to glass to metal seal may be nickel or stainless steel or a combination to give the optimum bond strength.

In embodiments using a metal disc, this disc may have pins or teeth protruding therefrom or a serrated edge to be pressed or keyed into the anode. Such pins or teeth may have a length less than the length of the anode projecting from the overlapped electrode to avoid a short circuit in the cell.

In some embodiments, a disc that possesses overhanging strips that may be folded over the anode (and optionally crimped) to grip onto the side of the anode. In some embodiments, a spring may be incorporated between the top of the housing and the metal disc to maintain the position of the metal disc on the anode. Such a spring may be made or coated with an insulating material, such as a silicon foam, to eliminate potential for a short circuit. Further, as mentioned above with respect to the cathode, conducting glues and resins may be used to assist in the attachment of the anode to an electrically conductive component.

Application of the Rechargeable Lithium Polymer Battery in Oilfield Use

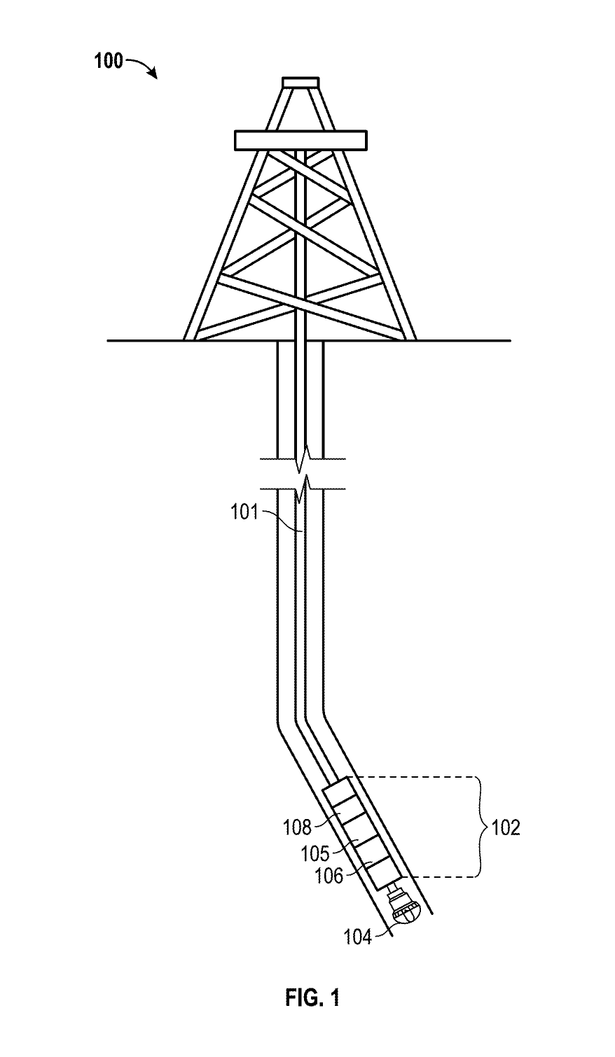

In general, some embodiments are related to methods of charging/recharging and/or discharging a lithium polymer battery in oilfield applications. As illustrated in FIG. 1, a drilling system (100) includes a bottom hole assembly (102) connected at the bottom end of a drill string (101) suspended within a wellbore. The bottom hole assembly (102) may include an a drill bit (104) at the lowermost end of the bottom hole assembly (102), a drill collar (106), and a motor (108). One or more other downhole tools may be located anywhere along the drill string (101) or along a wireline (not shown) in the wellbore when the drill string (101) and bottom hole assembly (102) are removed from the well. Further, in accordance with one or more embodiments, a battery (105) may be located along the drill string (101) or on a wireline (not shown) and thus any tubular string in a drilling system. In particular embodiments, the battery may be electrically connected to a component of motor (108) to receive energy therefrom. It should be understood that no limitation is intended by the arrangement of the drilling system, including the presence of absence of one or more components. As mentioned above, it is also envisioned that the drill string (101) may also be replaced by structures such as a wireline or any other apparatuses to convey the battery (105) into the wellbore, where the battery is electrically connected to one or more tools located on the wireline.

In this disclosure, components that are “electrically connected” are connected in such a way that electric current may flow between the components. Components that are electrically connected may include additional components that are connected between them. In addition, in some cases, a switch may be electrically connected to various components in a circuit. Even though a switch may be in an open position, which would break the circuit and prevent electrical flow, this does not prevent components from being electrically connected in accordance with the present disclosure. A switch is intended to be closed at certain times, and at those times, electrical current may flow between the components that are electrically connected.

In general, in some embodiments, the batteries may be charged/recharged by a motor that generates energy from wellbore fluid flow therethrough. The chemical reactions involved in charging/recharging the battery would simply be a reverse of the chemical reactions occurring in discharge of the battery. It is also within the scope of the present disclosure that the batteries disclosed herein may be charged at the surface after being returned to the surface as well as being charged downhole during the drilling process, with no limitation on the particular method(s) that may be used for charging the battery.

It is also within the scope of the present disclosure that methods to protect the internal circuitry of the battery may be employed to prevent the negative effects from overcharging the battery. For example, an additive may be added to the battery so that all of the charging current is used in a reversible cycle without increasing the voltage through a local oxidation/reduction cycle of the components. Further, electronic protection within the battery, such as incorporating a diode within the battery, is another method to prevent overcharging. Specifically, a diode in the circuit of the battery can remain closed until the battery is fully charged. When the battery is fully charged, the current may open the circuit to shunt the electrodes of the battery. More complex protection circuits may also be employed.

In order to maintain optimum battery life, proper charging/recharging and discharging of the battery may be employed to ensure that the battery remains close to maximum capacity. In some embodiments, constant current or voltage may be maintained through the battery during the charging. In some embodiments, current may be applied until a predetermined voltage across the battery is achieved. In one or more embodiments, an electronics board within battery may control charge process and upper voltage limit of battery.

In some embodiments, a gradual increase or decrease in the current or voltage may be used in charging/recharging the battery. For example, a greater voltage may be used initially in the charging/recharging process with the voltage gradually decreasing over time. Likewise, a similar decrease in the current may be used. Alternatively, a lower voltage may be used initially, with the voltage gradually increasing over time or through discreet steps.

Embodiments of the present disclosure may include at least one of the following advantages. For example, the components used in forming the cell may advantageously allow for a battery to be operable at higher temperatures and pressures than prior batteries, which are experienced in a downhole environment. Additionally, the offset design and common terminals may allow a large surface area of the cell laminate to be collected over a small diameter of a wound combined electrode, particularly for electrodes that are several meters long in the axial dimension. Further, the common terminal design means that long lengths of materials may be wound without the need for multi-tabbing.

Further, the use of a lithium polymer electrolyte battery may allow for recharging of the battery downhole when turbine power or other power is available in excess. Significant battery lifetime may be achieved so long as charging power matches that which is consumed during discharge (when the turbine or other power source is not providing power to the downhole tools). For example, in excess of 2000 hours life may be achieved for a cell using a repeating discharge/charge cycle of a 10 minute discharge and a 50 minute charge with a charge power of 0.25 W supplied to the cell.

While the invention has been described with respect to a limited number of embodiments, those skilled in the art, having benefit of this disclosure, will appreciate that other embodiments can be devised which do not depart from the scope of the invention as disclosed herein. Accordingly, the scope should be limited by the attached claims. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A battery for oilfield applications, comprising:
a housing; and
an electrolytic cell disposed in the housing, the electrolytic cell comprising:
a cathode comprising a cathode composite material coated on substrate, the cathode composite material comprising:
a polymeric continuous phase;
an active material;
a carbon source; and;
a first lithium salt;
an anode comprising lithium; and
a polymeric separator disposed between the cathode and anode, the polymeric separator comprising:
a first polymer crosslinked by a photoinitiator; and
a second lithium salt.

2. The battery of claim 1, wherein the active material is a vanadium oxide with a formula of VOₓ where x ranges from 0.5-3.

3. The battery of claim 2, wherein the active material comprises V₆O₁₃.

4. The battery of claim 1, wherein the polymeric continuous phase comprises polyalkylene oxide.

5. The battery of claim 1, wherein the polymeric separator further comprises a metal oxide filler.

6. The battery of claim 1, wherein the first polymer comprises polyalkylene oxide.

7. The battery of claim 1, wherein the first polymer possesses a weight average molecular weight of ranging from 100,000 g/mol to 4,500,000 g/mol.

8. The battery of claim 1, wherein the polymeric separator further comprises a polyimide mesh or porous film.

9. The battery of claim 1, wherein a molar ratio of heteroatom in the polymeric continuous phase to lithium in the first lithium salt in the composite cathode is in a range from 10:1 to 30:1.

10. The battery of claim 1, wherein a molar ratio of heteroatom in the first polymer to lithium in the second lithium salt is in a range from 10:1 to 30:1.

11. The battery of claim 1, wherein the battery is electrically connected to at least one downhole tool.

12. The battery of claim 1, wherein the photoinitiator comprises one or more of an acyl phosphine oxide, an alpha hydroxyl ketone, or a benzophenone.

13. The battery of claim 12, wherein the photoinitiator comprises a blend of one of each of an acyl phosphine oxide, an alpha hydroxyl ketone, and a benzophenone.

14. A method for the fabrication of a battery, the method comprising:
preparing a composite cathode material comprising an active material, a carbon source, a first lithium salt and a polymeric continuous phase;
preparing a polymeric separator comprising a polymer electrolyte by crosslinking the polymer electrolyte with a photoinitiator;
coating the composite cathode material on a substrate to form a cathode;
laminating the cathode with the polymeric separator;
placing a lithium anode offset to the cathode to form a combined electrode;
winding the combined electrode to form a elongated body; and
electrically connecting the anode at one axial end of the elongated body and the cathode substrate at the other axial end of the elongated body to conductive components.

15. The method of claim 14, further comprising:
placing the elongated body in a housing.

16. The method of claim 14, further comprising welding the cathode to a central mandrel around which the cathode and anode are wound.

17. The method of claim 14, wherein preparing the polymeric separator comprises dissolving at least a portion of polymer electrolyte in an organic solvent selected from acetonitrile, propan-2-ol, or combinations thereof.

18. The method of claim 14, wherein the photoinitiator comprises one or more of an acyl phosphine oxide, an alpha hydroxyl ketone, or a benzophenone.

19. The method of claim 18, wherein the photoinitiator comprises a blend of one of each of an acyl phosphine oxide, an alpha hydroxyl ketone, and a benzophenone.

20. The method of claim 14, wherein the preparing comprises coating the composite cathode material onto the substrate by a doctor blade method or hot melt extrusion.

21. The method of claim 14, wherein the preparing the composite cathode material comprises mixing the active material and the carbon source by one of ball milling, mechanofusion processing, or through the use of a mixer.

22. A downhole system having a rechargeable lithium polymer battery, comprising:
at least one downhole tool disposed within a wellbore;
a battery in electrical connection with the at least one downhole tool; wherein the battery comprises the battery of claim 1.

23. The downhole system of claim 22, further comprising at least one motor in electrical connection with the battery.

24. A method for using a battery in oilfield applications, the method comprising:
discharging the battery of claim 1 located on a tubular string and electrically connected to at least one downhole tool to power the at least one downhole tool.

25. A method for recharging a battery in oilfield applications, the method comprising:
charging the battery of claim 1 located on a tubular string and electrically connected to a downhole motor.
